(19) United States
(12) Patent Application Publication
(10) Pub. No.: US 2008/0039285 A1
(43) Pub. Date: Feb. 14, 2008

(54) Automatic transmission

(76) Inventor: Sung Hoon Park, Seongnam-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/595,401

(22) Filed: Nov. 8, 2006

(30) Foreign Application Priority Data
Aug. 14, 2006 (KR) 10-2006-0076791

(51) Int. Cl. F16H 61/00

(52) U.S. Cl. 477/116

(57) ABSTRACT

An automatic transmission includes: a transmission case; a support installed vertically in the transmission case; a hydraulic pump housing installed in the transmission case; a hydraulic pressure chamber attached to a first side of the support; a transfer drive gear for transferring torque to an output shaft, the transfer drive gear being attached to a second side of the support; a brake retainer coupled to the hydraulic pressure chamber and attached to the center support; a first brake receiving a first operating hydraulic pressure from the hydraulic pressure chamber and splined to the transmission case through the brake retainer; and a second brake receiving a second operating hydraulic pressure from the hydraulic pump housing, connected to the brake retainer, and splined to the transmission case.

### CROSS-REFERENCE TO RELATED APPLICATION

This application claims priority to and the benefit of Korean Patent Application No. 10-2006-0076791 filed in the Korean Intellectual Property Office on Aug. 14, 2006, the entire contents of which are incorporated herein by reference.

### BACKGROUND OF THE INVENTION

(a) Field of the Invention

The present invention relates to an automatic transmission. More particularly, the present invention relates to an automatic transmission having improved durability as a consequence of a brake retainer supporting first and second brakes with a uniform pressure.

(b) Description of the Related Art

A typical shift mechanism of an automatic transmission utilizes a plurality of planetary gear sets. A power train of such an automatic transmission changes rotating speed and torque received from a torque converter, and accordingly transmits the changed torque to an output shaft. In addition, a brake variably stops operational elements of the planetary gear sets.

In a conventional automatic transmission, a brake piston is mounted in a brake cylinder, brake plates are connected to a transmission case, and brake disks are disposed between the brake plates. In addition, a snap ring supports the brake plates.

Part of the transmission case is typically removed in order to install an output shaft. Therefore, the snap ring cannot support the brake with a uniform pressure. A non-uniform pressure is applied to the brake plates and the brake disks, and thus durability of the transmission deteriorates.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides an automatic transmission that supports brake plates and brake disks with a uniform pressure to improve durability. Brakes directly receive an operating hydraulic pressure from a valve body and components of an automatic transmission are effectively arranged.

An automatic transmission according to an exemplary embodiment of the present invention includes: a transmission case; a center support disposed vertically in the transmission case; a hydraulic pump housing in the transmission case; a hydraulic pressure chamber on one side of the center support; a transfer drive gear for transferring torque to an output shaft, the transfer drive gear being disposed on the other side of the center support; a brake retainer coupled to the hydraulic pressure chamber and attached to the center support; a first brake receiving an operating hydraulic pressure from the hydraulic pressure chamber and splined to the transmission case through the brake retainer; and a second brake receiving an operating hydraulic pressure from the hydraulic pump housing, connected to the brake retainer, and splined to the transmission case.

The transmission may further include a roller bearing for supporting the transfer drive gear disposed on an interior circumference of the center support. An outer race of the roller bearing may be integrally formed with the center support.

The hydraulic pressure chamber may be mounted on an exterior circumference of the outer race.

The first brake and the second brake may be coaxial.

The first brake may include: a first brake cylinder connected to and receiving hydraulic pressure from the hydraulic pressure chamber; a first brake piston mounted in the first brake cylinder; first brake plates connected to the first brake piston and splined to the transmission case; first brake disks disposed between the first brake plates; and a first brake hub connected to the first brake disks.

The second brake may include: a second brake cylinder connected to and receiving hydraulic pressure from the hydraulic pump housing; a second brake piston mounted in the second brake cylinder; second brake plates connected to the second brake piston and splined to the transmission case; second brake disks disposed between the second brake plates; and a second brake hub connected to the second brake disks.

An opening may be provided on an exterior circumference of the brake retainer and the first brake plates may be splined to the transmission case through the opening.

The brake retainer may have one end coupled with the hydraulic pressure chamber, and the other end connected to the second brake plates.

An oil pathway may be formed where the brake retainer and the hydraulic pressure chamber are coupled with each other.

The brake retainer may be fixed to the center support by a bolt.

### BRIEF DESCRIPTION OF THE. DRAWINGS

FIG. 1 is a schematic diagram of a power train according to an exemplary embodiment of the present invention;

FIG. 2 is an operational chart for frictional members of the power train shown in FIG. 1;

FIG. 3 is a cross-sectional view of an automatic transmission according to an exemplary embodiment of the present invention;

FIG. 4 is a partially enlarged view of FIG. 3; and

FIG. 5 is a perspective view that shows a coupled structure of a brake retainer and a hydraulic pressure chamber according to an exemplary embodiment of the present invention.

### DETAILED DESCRIPTION OF EXEMPLARY EMBODIMENTS

Exemplary embodiments of the present invention will hereinafter be described in detail with reference to the accompanying drawings.

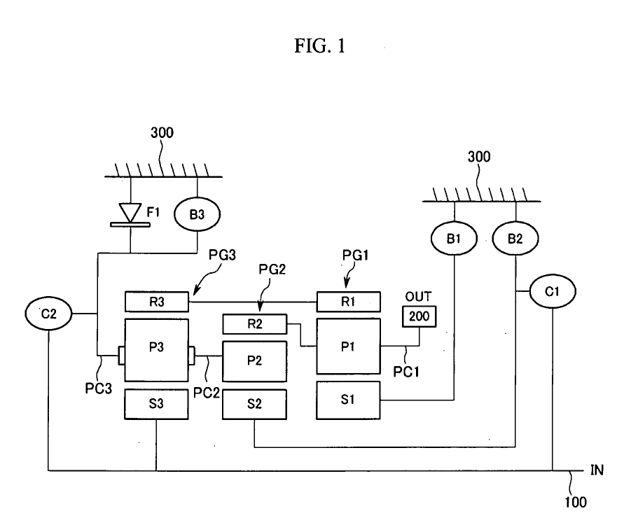

Referring to FIG. 1, a power train of an automatic transmission includes a first planetary gear set PG1, disposed at an entrance of the automatic transmission, a second planetary gear set PG2, and a third planetary gear set PG3, sequentially disposed proximal to the first planetary gear set PG1. Planetary gear sets PG1-3 may be single pinion planetary gear sets.

An input shaft 100 receives torque from an engine (not shown), and an output shaft 200 outputs torque from the power train. The power train may further include a transmission case 300.

The first planetary gear set PG1 includes a first sun gear S1, a first planet carrier PC1, and a first ring gear R1. A first pinion gear P1, engaged with the first ring gear R1 and the first sun gear S1, is connected to and supported by the first planet carrier PC1.

The second planetary gear set PG2 includes a second sun gear S2, a second planet carrier PC2, and a second ring gear R2. A second pinion gear P2, engaged with the second ring gear R2 and the second sun gear S2, is connected to and supported by the second planet carrier PC2.

The third planetary gear set PG3 includes a third sun gear. S3, a third planet carrier PC3, and a third ring gear R3. A third pinion gear PC3, engaged with the third ring gear R3 and the third sun gear S3, is connected to and supported by the third planet carrier PC3.

The first ring gear R1 is fixedly connected to the third ring gear R3, and the first planet carrier PC1 is fixedly connected to the second ring gear R2. The second planet carrier PC2 is fixedly connected to the third planet carrier PC3.

The third sun gear S3 always acts as an input member by being fixedly connected to the input shaft 100, and the first planet carrier PC1 always acts as an output member by being fixedly connected to the output shaft 200.

The second sun gear S2 is variably connected to the input shaft 100 via a first clutch C1, and the third planet carrier PC3 is variably connected to the input shaft 100 via a second clutch C2.

The first sun gear S1 is variably connected to the transmission case 300 via a first brake B1, the second sun gear S2 is variably connected to the transmission case 300 via a second brake B2, and the third planet carrier PC3 is variably connected to the transmission case 300 via a third brake B3.

In addition, a one-way clutch F1 is disposed in parallel with the third brake B3 between the third planet carrier PC3 and the transmission case 300.

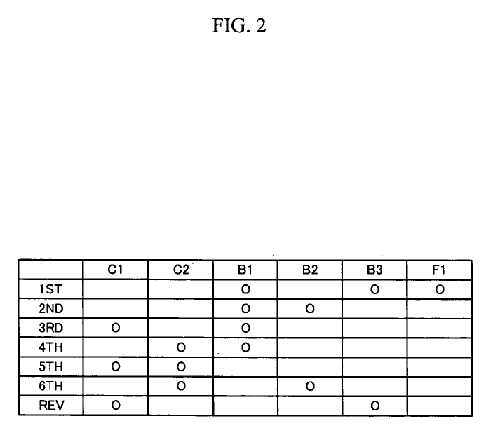

As shown in FIG. 2, the first and third brakes B1 and B3 and the one-way clutch F1 are operated at a first forward speed, the first and second brakes B1 and B2 are operated at a second forward speed, and the first clutch C1 and the first brake B1 are operated at a third forward speed. The second clutch C2 and the first brake B1 are operated at a fourth forward speed, the first and second clutches C1 and C2 are operated at a fifth forward speed, and the second clutch C2 and the second brake B2 are operated at a sixth forward speed. The first clutch C1 and the third brake B3 are operated at a reverse speed.

Shifting processes will be understood by persons of ordinary skill in the art based on the teachings herein, with reference to FIG. 2, and thus will not be described in further detail.

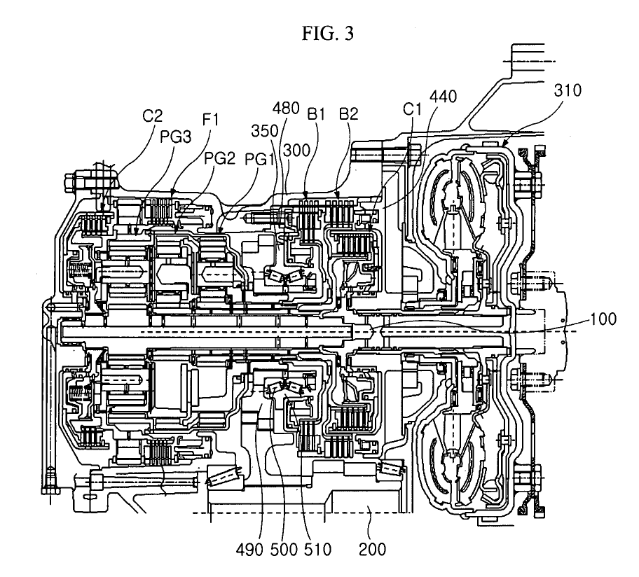

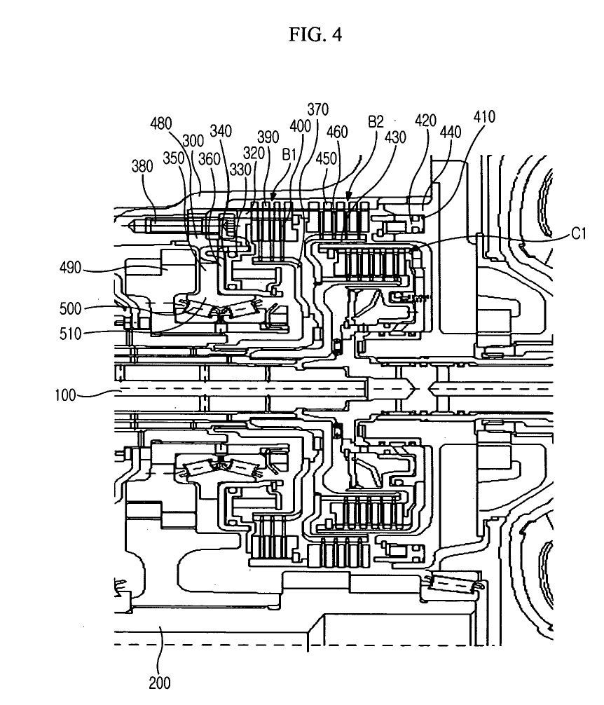

As shown in FIGS. 3 and 4, an automatic transmission according to an exemplary embodiment of the present invention includes the input shaft 100 horizontally disposed at a middle portion of the transmission case 300. The output shaft 200 is disposed in parallel with the input shaft 100 at a lower portion of the transmission case 300.

A torque converter 310 is mounted at one side of the transmission case 300, and a hydraulic pump housing 440 is mounted at one side of the torque converter 310. A center support 350 is vertically installed in the transmission case 300 and divides the transmission case 300 into two parts. In addition, a hydraulic pressure chamber 360 is mounted on one side of the center support 350, and a transfer drive gear 490 is mounted on the other side of the center support 350. The transfer drive gear 490 transmits torque of the power train to the output shaft 200.

In addition, a roller bearing 500 for supporting the transfer drive gear 490 is mounted on an interior circumference of the center support 350. An outer race 510 of the roller bearing 500 is integrally formed with the center support 350.

In addition, the hydraulic pressure chamber 360 is mounted on an exterior circumference of the outer race 510.

The left portion of the transmission case 300 in FIG. 3, being divided by the center support 350, includes the first, second, and third planetary gear sets PG1, PG2, and PG3, the second clutch C2, the third brake B3, the one-way clutch F1, and the transfer drive gear 490. The right portion of the transmission case 300 in FIG. 3, being divided by the center support 350, includes the first and second brakes B1 and B2 and the first clutch C1.

As shown in FIG. 4, the first and second brakes B1 and B2 are supported by a brake retainer 320 fixed to an interior circumference of the transmission case 300.

The first brake B 1 includes a first brake cylinder 340, a first brake piston 330, a first brake hub 370, first brake plates 390, and first brake disks 400. The first brake cylinder 340 is connected to and receives hydraulic pressure from the hydraulic pressure chamber 360. The first brake piston 330 is mounted in the first brake cylinder 340 and compresses the first brake plates 390 and the first brake disks 400 by the hydraulic pressure received from the hydraulic pressure chamber 360.

The first brake plates 390 are connected to the first brake piston 330. The first brake plates 390 are splined to the transmission case 300 through the brake retainer 320.

In addition, the first brake disks 400 are disposed between the first brake plates 390 and are connected to the first brake hub 370.

Therefore, when the first brake piston 330 receives the hydraulic pressure from the hydraulic pressure chamber 360 and is operated, the first brake plates 390 and the first brake disks 400 are compressed by the hydraulic pressure. In this case, the brake retainer 320 having a cylindrical shape supports the first brake plates 390 such that a uniform pressure is applied to the first brake plates 390 and the first brake disks 400.

The second brake B2 includes a second brake cylinder 410, a second brake piston 420, a second brake hub 430, second brake plates 450, and second brake disks 460. In addition, the second brake B2 is coaxial with the first brake B1.

The second brake cylinder 410 is connected to and receives hydraulic pressure from the hydraulic pump housing 440. The second brake piston 420 is mounted in the second brake cylinder 410 and compresses the second brake plates 450 and the second brake disks 460 by the hydraulic pressure received from the hydraulic pump housing 440.

The second brake plates 450 are connected to the second brake piston 420. In addition, the second brake plates 450 are splined to the transmission case 300. In addition, the left end of the second brake plates 450 in FIG. 4 is connected to the brake retainer 320.

The second brake disks 460 are disposed between the second brake plates 450 and are connected to the second brake hub 430.

Therefore, when the second brake piston 420 receives the hydraulic pressure from the hydraulic pump housing 440 and is operated, the second brake plates 450 and the second brake disks 460 are compressed by the hydraulic pressure. In this case, the brake retainer 326 having a cylindrical shape supports the second brake plates 450 and a uniform pressure is applied to the second brake plates 450 and the second brake disks 460.

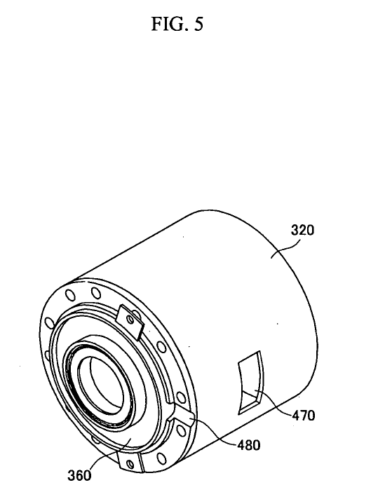

FIG. 5 is a perspective view that shows a coupled structure of a brake retainer and a hydraulic pressure chamber according to an exemplary embodiment of the present invention.

As shown in FIG. 5, the brake retainer 320 has a cylindrical shape and supports the first brake B1 and the second brake B2.

The hydraulic pressure chamber 360 is coupled to one end of the brake retainer 320, and the second brake plates 450 are connected to the other end of the brake retainer 320. In addition, an opening 470 is formed on an exterior circumference of the brake retainer 320. The first brake plates 390 are splined to the transmission case 300 through the opening 470 of the brake retainer 320. Therefore, the brake retainer 320 supports the first brake B1 and the second brake B2.

In addition, the brake retainer 320 may be fixed to the center support 350 by a bolt 380.

An oil pathway 480 is formed where the brake retainer 320 and the hydraulic pressure chamber 360 are coupled with each other, and thus the hydraulic pressure chamber 360 directly receives oil from a valve body (not shown). Therefore, the oil of the valve body is directly supplied to the hydraulic pressure chamber 360 through the oil pathway 480, and the first brake piston 330 is operated by the oil supplied from the valve body.

According to an exemplary embodiment of the present invention, first and second brakes are supported by a brake retainer and thus durability of the first and second brakes may be improved. Also, since a snap ring supporting the brakes is not used, the production cost may be reduced. In addition, since the first and second brakes are coaxial with each other, the length of the automatic transmission may be reduced. Since the hydraulic pressure chamber directly receives the hydraulic pressure from the valve body, reliability of a hydraulic pressure performance may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An automatic transmission, comprising:
a transmission case;
a support disposed substantially vertically in the transmission case;
a hydraulic pump housing disposed in the transmission case;
a hydraulic pressure chamber attached to a first of the support;
a transfer drive gear for transferring torque to an output shaft, the transfer drive gear being attached to a second side of the support;
a brake retainer coupled to the hydraulic pressure chamber and attached to the support;
a first brake receiving a first operating hydraulic pressure from the hydraulic pressure chamber and splined to the transmission case through the brake retainer; and
a second brake receiving a second operating hydraulic pressure from the hydraulic pump housing, connected to the brake retainer, and splined to the transmission case.

2. The automatic transmission of claim 1, further comprising a roller bearing for supporting the transfer drive gear disposed at an interior surface of the support.

3. The automatic transmission of claim 2, wherein an outer race of the roller bearing is integrally formed with the support.

4. The automatic transmission of claim 3, wherein the hydraulic pressure chamber is disposed at an exterior surface of the outer race.

5. The automatic transmission of claim 1, wherein the first brake and the second brake are substantially coaxial with each other.

6. The automatic transmission of claim 5, wherein the first brake comprises:
a first brake cylinder connected to and receiving the first operating hydraulic pressure from the hydraulic pressure chamber;
a first brake piston in the first brake cylinder;
first brake plates connected to the first brake piston and splined to the transmission case;
first brake disks disposed between the first brake plates; and
a first brake hub connected to the first brake disks.

7. The automatic transmission of claim 5, wherein the second brake comprises:
a second brake cylinder connected to the hydraulic pump housing and receiving the second operating hydraulic pressure from the hydraulic pump housing;
a second brake piston in the second brake cylinder;
second brake plates connected to the second brake piston and splined to the transmission case;
second brake disks disposed between the second brake plates; and
a second brake hub connected to the second brake disks.

8. The automatic transmission of claim 5, further comprising an opening on an exterior surface of the brake retainer, wherein the first brake plates are splined to the transmission case through the opening.

9. The automatic transmission of claim 8, wherein the brake retainer has a first end attached to the hydraulic pressure chamber, and a second end attached to the second brake plates.

10. The automatic transmission of claim 9, further comprising an oil pathway disposed at a place at which the brake retainer and the hydraulic pressure chamber are attached to each other.

11. The automatic transmission of claim 1, wherein the brake retainer is attached to the support by a bolt.
